(19) United States
(12) Patent Application Publication
(10) Pub. No.: US 2008/0285125 A1
(43) Pub. Date: Nov. 20, 2008

(54) OPTICAL PANEL FOR FRONT PROJECTION UNDER AMBIENT LIGHTING CONDITIONS

(75) Inventors: Chuan Lee, Greer, SC (US); Kenneth L. Strickland, Simpsonville, SC (US); Benjamin M. Wicker, Ware Shoals, SC (US); Kimiaki Miyamoto, Greenwood, SC (US); James F. Shanley, Westborough, MA (US); Richard S. Sarvas, Huntington, WV (US)

Correspondence Address: THOMPSON HINE L.L.P.;Intellectual Property Group, P.O. BOX 8801, DAYTON, OH, 45401-8801, US

(73) Assignees: FUJIFILM MANUFACTURING U.S.A. INC., Greenwood, SC (US); Scram Technologies, Inc., Bowie, MD (US)

(21) Appl. No.: 11/750,682

(22) Filed: May 18, 2007

(51) Int. Cl. G03B 21/56

(52) U.S. Cl. 359/449

(57) ABSTRACT

An optical display panel that comprises a plurality of stacked optical waveguides including a plurality of stacked optical waveguides each having an optical core with a first and a second surface, a cladding layer on each of the first and second surfaces of the core, a diffuser on the front face of the stacked waveguides, and a reflector on the back face of the stacked waveguides. The stacked waveguides form a front face and a back face and images are viewed from the front face of the stacked waveguides, which are planar.

### BACKGROUND

The present application relates generally to an optical panel for use as a front projection screen.

Optical waveguides have been used to develop front projection optical display screens as taught in U.S. Pat. Nos. 7,116,873, 6,741,779, and 6,535,674 to Veligdan, which are incorporated herein by reference. The waveguides disclosed include a central core disposed between cladding layers where the index of refraction of the cladding is less than the index of refraction for the core. The wave guides are stacked together and secured to form the projection screen. Each waveguide may include a black layer disposed in or between the cladding layers on the adjacent waveguides. The faces on one end of the plurality of stacked waveguides form an outlet face at one end and a back face at the opposite end. A reflector that reflects light within the waveguides is connected to the back face. Light enters the front outlet faces of the waveguides and is internally reflected to the back face where it strikes the reflector and is reflected back within the waveguides and for projection from the front or outlet face of the display screen.

Ambient light often interferes with the projected image on many conventional screens such that the image has low brightness, low contrast, and high glare under ambient conditions. To view the image, the lights in the room are either turned off or dimmed, and/or light coming in from outside the room is shielded. Another problem found in front projection screens is the presence of a reflective hot spot. A reflective hot spot is an area or spot which gives unusual high reflective bright light across the screen surface. The hot spot may be an enlarged and/or greatly blurred reflection of bright light. The unusual brightness of the hot spot may obstruct the view of the image by distorting the contrast with portion of the image surrounding the hot spot. The viewer may be “blinded” by the hot spot such that the rest of the image appears blurry. Therefore, there is a need for an optical panel that has good screen properties (e.g. high brightness, high contrast, low glare, and no hot spot) under ambient room conditions or any other various lighting conditions without the need to alter the lighting conditions of the surroundings.

### SUMMARY

In one embodiment, disclosed herein an optical display panel comprises a plurality of stacked optical waveguides. Each stacked waveguide is planar, has a front face and a back face at opposite ends of the stacked waveguides, and includes an optical core having a first and a second surface, a cladding layer on each of the first and second surfaces of the core, a diffuser on the front face of the stacked waveguides, and a reflector on the back face of the stacked waveguides. Images are viewed from the front face of the stacked waveguides. Generally the waveguides have a thin rectangular cross-section.

Another embodiment of an optical display panel comprises a plurality of stacked waveguides. Each stacked waveguide is planar, has a front face and a back face at opposite ends of the stacked waveguides, and includes an optical core having a first and a second surface, a cladding layer on each face of the first and second surfaces of the core, a front diffuser on the front face of the stacked waveguides, a back diffuser on the back face of the stacked waveguide, and a reflector behind the back diffuser on the face of the diffuser opposite the waveguide. Images are viewed from the front face of the stacked waveguides.

Other aspects of the disclosed optical waveguides and associated methods will become apparent from the following description, the accompanying drawings and the appended claims.

### BRIEF DESCRIPTION OF THE DRAWINGS

FIG. 1 is a side elevational view of a waveguide showing the acceptance angle;

FIGS. 2 and 3 are side elevational views of embodiments of an optical panel;

FIGS. 4-10 are side elevational views of various embodiment of waveguides; and

FIG. 11 is a side elevational view of one embodiment of an optical panel including a dichroic filter.

### DETAILED DESCRIPTION

It is to be understood that the figures and descriptions of the present invention may have been simplified to illustrate elements that are relevant for a clear understanding of the present invention, while eliminating, for purposes of clarity, other elements found in a typical projection system. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of structures of the present invention and that structures falling within the scope of the present invention may include structures different than those shown in the drawings. Reference will now be made to the drawings wherein like structures are provided with like reference designations.

As used herein the term “waveguide” means a device for guiding the flow of electromagnetic waves along a desired path. Waveguides include a core material bounded by a cladding wherein the index of refraction of the cladding is less than the index of refraction of the core. The waveguide may further include a light absorbing layer and/or an adhesive to adhere a plurality of waveguides together.

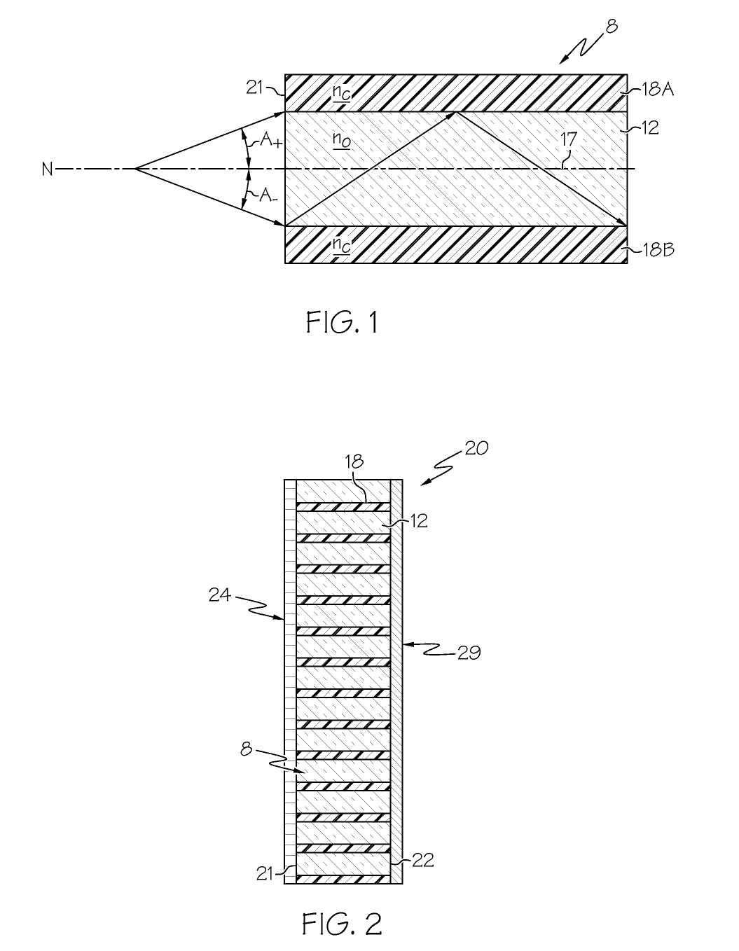

In simple terms, the behavior of light entering the core material in a waveguide is fundamentally controlled by the property of the core, cladding, any other layers if included, and the medium surrounding the waveguide. As illustrated in FIG. 1, a light ray entering waveguide 8 at core 12 having an axis 17 is either refracted into the cladding 18A, 18B and attenuated (absorbed), or it is totally internally reflected at the core/cladding boundary. Total internal reflection is the reflection of the total amount of incident light at the boundary between the core and cladding. In this manner light travels within the core along the length of the waveguide. The maximum angle at which the light ray may enter core 12 and travel by total internal reflection within the core is termed the acceptance angle A. The value of the acceptance angle depends mainly on the properties, including the refractive index, of the selected core and cladding. The acceptance angle A is measured between the incident ray and the normal line N to the front face 21 of core 12 and may be positive or negative. The larger the difference in refractive index between core 12 and the cladding 18A, 18B, the larger the acceptance angle may be for light rays entering core 12 to be totally internally reflected.

As used herein the term “panel” means a plurality of waveguides stacked and secured to one another such that the panel may be used for viewing images. The panel may be part of a screen used in visual projection applications.

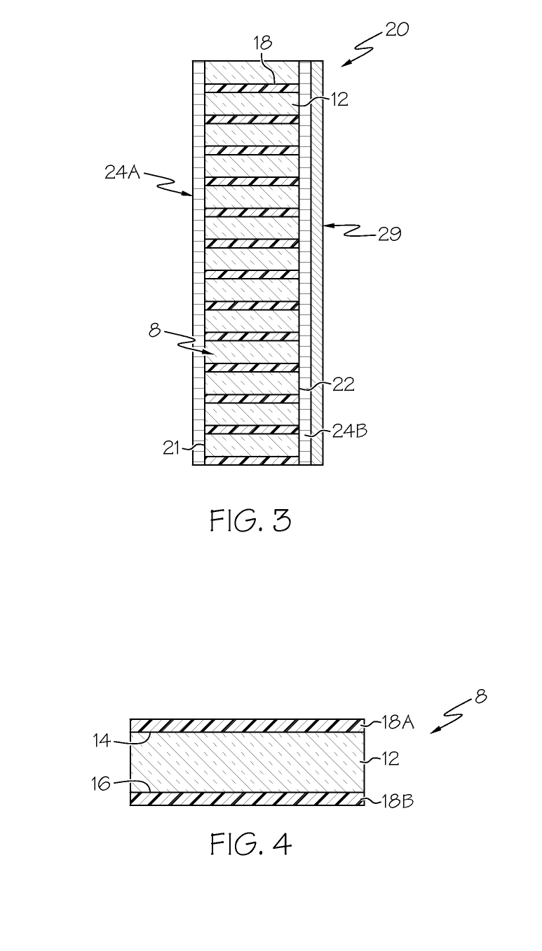

As shown in FIG. 2, one embodiment of a panel 20 includes a plurality of stacked optical waveguides 8, wherein the stacked optical waveguides 8 form a front face 21 and a back face 22 at opposing ends of the stacked waveguides 8. A diffuser 24 is on the front face 21 of the stacked waveguides 8. A reflector 29 is on back face 22 of the stacked waveguides 8. Reflector 29 may be a reflective material or reflective substrate as described in more detail below. In one embodiment, the waveguides 8 may be in the form of planar sheets or ribbons. The waveguides 8 include an optical core 12 and at least one cladding layer 18 that may include a light absorbing material. In other embodiment, cladding layer 18 may be clear and a separate light absorbing layer may be applied to the cladding layers between adjacent waveguides 8. In another embodiment, as shown in FIG. 3, panel 20 may include a front diffuser 24A and a back diffuser 24B. In one embodiment, back diffuser 24B may be between the back face 22 of the stacked waveguides 8 and the reflector 29. In another embodiment, back diffuser 24B may be part of the reflector 29.

FIGS. 4-10 show various embodiments of waveguides, generally designated 8. The waveguides 8, as shown in FIG. 4, include an optical core 12 having a first surface 14 and a second surface 16, a first cladding layer 18A applied to the first surface 14 of core 12, and a second cladding layer 18B applied to the second surface 16 of core 12. The core may be provided or prepared and may be a sheet of material with the desired refractive index for the chosen panel parameters. One important parameter is the acceptance angle desired for light entering the panel. The core may have a thickness of 10 mil, 20 mil, or any other thickness that will work in the manufacturing process and result in a panel with the desired acceptance angle and other screen characteristics. The cladding layer may be about 0.1 μm to 25 μm thick. In one embodiment, cladding layers 18A, 18B may include a light absorbing material. The light absorbing material may be any suitable light absorbing material, such as carbon black, a pigment, or a dye. The light absorbing material may be a powder or a liquid dispersion.

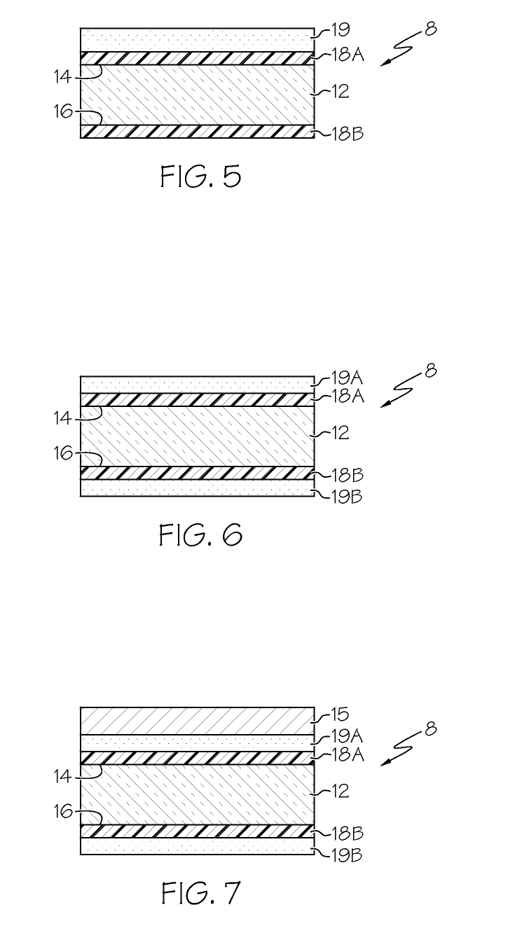

FIGS. 5 and 6 show that waveguides 8 may further include a light absorbing composition 19. Light absorbing composition 19 includes a light absorbing material such as carbon black, a pigment or a dye. In one embodiment, light absorbing composition 19 may form a single light absorbing layer on the first cladding layer 18A, as shown in FIG. 5. In another embodiment, light absorbing composition 19 may form two light absorbing layers where a first light absorbing layer 19A is on the first cladding layer 18A and a second light absorbing layer 19B is on the second cladding layer 18B, as shown in FIG. 6. In another embodiment, the light absorbing composition 19 may include an adhesive polymer.

As shown in FIGS. 7 and 8, waveguides 8 may further include a layer of an adhesive composition 15 to adhere or bond adjacent stacked waveguides together in forming the optical display panel. In one embodiment, adhesive composition 15 may form a single adhesive layer on the first light absorbing layer 19A, as shown in FIG. 7. In another embodiment, adhesive composition 15 may form two adhesive layers where one adhesive layer is on the first light absorbing layer 19A and a second adhesive layer is on the second light absorbing layer 19B, as shown in FIG. 8.

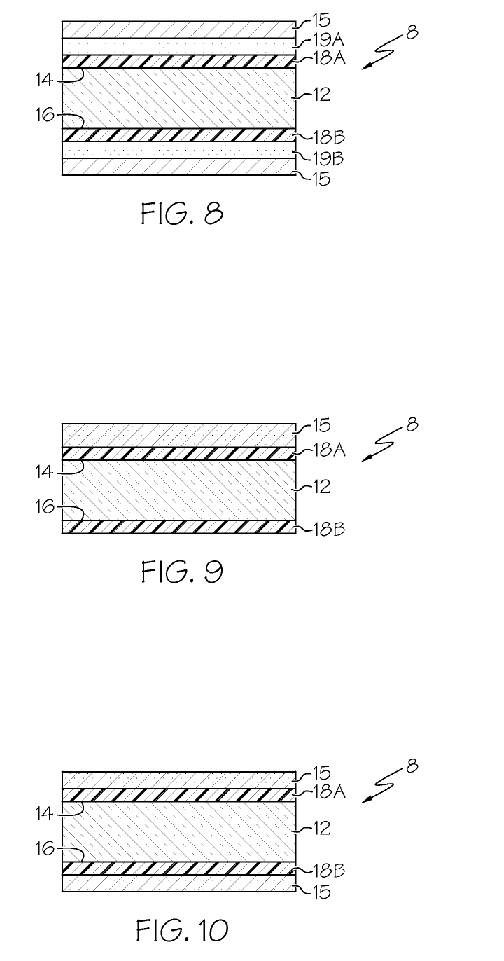

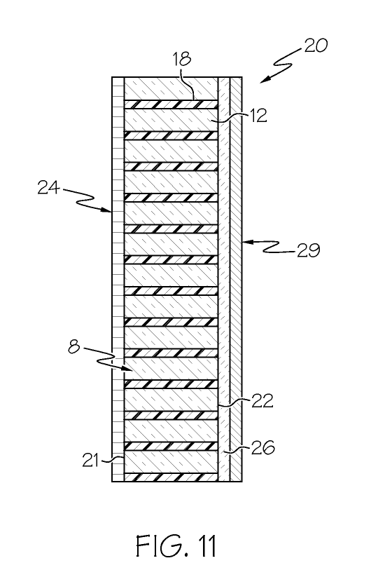

FIGS. 9 and 10 show waveguides 8 having an adhesive layer 15 applied to the first cladding layer 18A or the first and second cladding layers 18A, 18B without a light absorbing layer in between. In one embodiment, the adhesive layer 15 may include a light absorbing material.

In another embodiment as illustrated in FIG. 11, a dichroic filter 26 may be positioned between the back face 22 and the reflector 29. The dichroic filter 26 may be selected to substantially only pass light with the red, green and blue wavelengths present in the image light from the projector. Since most projectors project images with discrete wavelength red, green, and blue light, using a dichroic filter 26 with pass bands at these wavelengths will eliminate unwanted ambient light with out-of-band wavelengths. Further, for projectors with laser or LED light sources whose emitted image light exists in narrow bands, the dichroic filter 26 would eliminate a substantial amount (if not all) of out-of-band light. When ambient light enters the waveguides from the front face 21, then the only ambient light reflected back out the diffuser 24 (i.e. if any) would be ambient light that has the same wavelengths as the projected image light. All other ambient light will be blocked by the dichroic filter 26. Multiple dichroic filter 26 layers may optionally be employed each having suitable pass bands. For example, preferably each dichroic filter 26 will have a specific pass band corresponding to the red, green, and blue light, respectively. Alternatively, in embodiments using a back diffuser 24B, the back diffuser 24B may be placed either between the back face 22 and the dichroic filter 26, or between the dichroic filter 26 and the reflector 29. Two back diffusers may alternatively be utilized, one placed between the back face 22 and the dichroic filter 26, and the other placed between the dichroic filter 26 and the reflector 29.

The optical core may be any optical grade material deemed suitable for optical waveguides. For example, the optical core may include one or more of the following: polycarbonates, polymethylmethacrylate (PMMA), glass, polyesters, cellulose, cyclic olefins and/or copolymers thereof, or other suitable optical grade materials. The optical core may be one of the materials listed in Table 1 above or combinations thereof. Examples of the polyester cores include polyethylene terephthalate, polyethylene naphthalate or a combination thereof. Cores are selected that have excellent optical properties and will transmit light with minimal distortion or absorption of light. To provide good viewing characteristics, the optical core may have a percent transmission of between about 80 to about 100%. Transmissions less than 80 % may absorb or scatter more light, thereby reducing the overall brightness of the resulting waveguide.

In one embodiment the selected optical core may have a refractive index between about 1.4 to about 1.6. A polycarbonate core may have a refractive index of about 1.58. A PMMA core may have a refractive index of about 1.48. A cellulose core may have a refractive index of about 1.54. A polyethylene terephthalate core may have a refractive index of about 1.57.

The cladding layers of the various waveguide embodiments disclosed herein include a cladding material. The cladding material may be any material having an index of refraction that is lower than the index of refraction of the optical core. In one embodiment, the cladding material may be a polyurethane, clear coat containing dyes, silicones, cyanoacrylates, low index refraction epoxies, plastics, or combinations thereof. In another embodiment, the cladding material may be any polymer or polymer mixture that has an index of refraction that is lower than the index of refraction of the optical core and will result in a waveguide with the desired acceptance angle range. Representative examples of the cladding material include a butadiene, a polyester, a polyvinyl pyrrolidone, an acrylic polymer or copolymer, a polyethylene oxide, a polyvinylalcohol, an epoxy resin, an acrylate, an acrylate ester, or combinations thereof. In one embodiment, the waveguide may have an acceptance angle of ±5 to ±40°. In another embodiment, the waveguide may be designed to have an acceptance angle of ±5 to ±30°.

Below are examples of various cladding material, however, the cladding material is not to be construed as limited thereto. In one embodiment, the butadiene may be a styrene butadiene, a carboxylated styrene butadiene or combinations thereof available from Dow Reichhold Specialty Latex or Mallard Creek Polymers. In another embodiment, the polyester may be an anionic liquid polyester available from EvCo Research LLC. Polyvinyl pyrrolidone may be available from BASF. In one embodiment, the acrylic polymer, copolymer, or latex may be a styrene acrylic, vinyl acrylic, or carboxylated acrylic or mixtures thereof. The acrylic polymer, copolymer, or latex may be available from Ciba Specialty Chemicals, Dow Reichhold Specialty Latex, Para-Chem, or Specialty Polymers, Inc. Polyethylene oxide may be available from The Dow Chemical Company. Polyvinyl alcohol may be available from Dupont. The epoxy resin may be a dispersion that may be available from Chemtrec or an epoxy modified alkyl resin from Surface Specialties. The acrylate may be n-butylacrylate latex, polyethylene glycol diacrylate, carboxylated styrene acrylate, or other acrylates available from Sartomer Company or Dow Reichhold Specialty Latex. Acrylate esters may be available from Sartomer Company.

In one embodiment, the core selected is a polycarbonate core, and the cladding material selected for use with the polycarbonate core is a polystyrene butadiene available from Mallard Creek Polymers. In another embodiment, the core selected is a PMMA, and the cladding material selected for use with the PMMA is a vinyl acrylic or a carboxylated acrylic copolymer or mixtures thereof, available from Ciba Specialty Chemicals. In one embodiment the cladding material is a mixture of carboxylated acrylic copolymers, Glascol® RP4 and Glascol® RP3 microemulsions that may be crosslinked by their carboxylic functionality. The RP3 and RP4 may be mixed as about 25% RP3 with about 75% RP4 to about 75% RP3 to about 25% RP4.

The cladding may include a surfactant. The surfactant is usually added to the coating composition forming the cladding to aid in the application of the cladding composition onto the core. The surfactant helps the cladding composition flow smoothly during manufacturing. The cladding composition may also include water. The resulting cladding composition may be a mixture of liquids to form a solution that may be mixed and used in the manufacturing process.

Examples of surfactants include anionic surfactants, amphoteric surfactants, cationic surfactants, and non-ionic surfactants. Examples of anionic surfactants include alkylsulfocarboxylates, alpha olefin sulfonates, polyoxyethylene alkyl ether acetates, N-acylaminoacids and salts thereof, N-acylmethyltaurine salts, alkylsulphates, polyoxyalkylether sulphates, polyoxyalkylether phosphates, rosin soap, castor oil sulphate, lauryl alcohol sulphate, alkyl phenol phosphates, alkyl phosphates, alkyl allyl sulfonates, diethylsulfosuccinates, diethylhexylsulfosuccinates, dioctylsulfosuccinates and the like. Examples of the cationic surfactants include 2-vinylpyridine derivatives and poly-4-vinylpyridine derivatives. Examples of the amphoteric surfactants include lauryl dimethyl aminoacetic acid betaine, 2-alkyl-N-carboxymethyl-N-hydroxyethyl imidazolinium betaine, propyldimethylaminoacetic acid betaine, polyoctyl polyaminoethyl glycine, and imidazoline derivatives.

Examples of non-ionic surfactants include non-ionic fluorinated surfactants and non-ionic hydrocarbon surfactants. Examples of non-ionic hydrocarbon surfactants include ethers, such as polyoxyethylene nonyl phenyl ether, polyoxyethylene octyl phenyl ether, polyoxyethylene dodecyl phenyl ether, polyoxyethylene alkyl allyl ethers, polyoxyethylene oleyl ethers, polyoxyethylene lauryl ethers, polyoxyethylene alkyl ethers, polyoxyalkylene alkyl ethers; esters, such as polyoxyethylene oleate, polyoxyethylene distearate, sorbitan laurate, sorbitan monostearate, sorbitan monooleate, sorbitan sesquioleate, polyoxyethylene monooleate, polyoxyethylene stearate; glycol surfactants and the like. The above-mentioned surfactants are typically added to the coating in an amount ranging from about 0.1 to 1000 mg/m², preferably from about 0.5 to 100 mg/m².

The cladding may optionally further comprise one or more conventional additives, such as biocides; pH controllers, matting agents, preservatives; defoamers; viscosity modifiers; dispersing agents; UV absorbing agents; anti-oxidants; and/or antistatic agents. These additives may be selected from known compounds and materials in accordance with the objects to be achieved. In one embodiment, the above-mentioned additives may be added in a range of 0 to 10% by weight, based on the solid content of layer.

The adhesive may be a rubber, a urethane, a cellulose derivative, a polyester, a polyacrylate, an epoxide, a silicone, a formaldehyde resin, a phenolic resin, a vinyl polymer, a polyether, a furane, a polyaromatic, or mixtures thereof. In one embodiment, the adhesive may be a dispersion. The dispersion may be aqueous or in other solvent. In one embodiment, the adhesive may be a hot melt. Examples of rubber based adhesives include natural rubber, derivatives of natural rubber, synthetic rubber, or derivative of synthetic rubber. The derivatives of synthetic rubber include butyl, polyisobutylene, styrene butadiene, acrylonitrile butadienes, neoprene, and chloroprene derivatives. Examples of urethane based adhesive include polyurethanes, polycarboxylated polyurethanes, and polyurethane polyesters. In one embodiment, the urethane based adhesives may be aromatic or aliphatic. Various urethanes may be available from CL Hauthaway & Sons Corporation or Noveon, Inc. Examples of cellulose derivative based adhesives include cellulose acetate, ethyl cellulose, and carboxy methyl cellulose. The polyester based adhesive may be saturated or unsaturated and examples thereof include polystyrene and polyamides. Examples of polyacrylate based adhesives include methacrylates, cyanoacrylates, and acrylamides. Examples of vinyl polymer based adhesives include polyvinyl acetate, polyvinyl acetal, and polyvinyl chloride. In one embodiment the adhesive may be an aliphatic or aromatic polyurethane polyester adhesive. Such adhesives may be an aqueous dispersion available from Cytec Industries, Alfa Adhesives, Helmitin Inc., and Bayer MaterialScience LLC.

In another embodiment, the adhesive composition may include a thermosetting resin. The thermosetting resin may be an epoxy resin selected from the group consisting of a biphenol epoxy, urethane modified epoxy, a rubber modified epoxy and mixtures thereof. In another embodiment, the thermosetting resin may be an aqueous dispersion. Examples of thermosetting epoxy resins useful in adhesive layer 20 are available from Resolution Performance Products, such as EPR-REZ™ resin 5520—a urethane-modified epoxy resin, EPR-REZ™ resin 3522—a solid Bisphenol A epoxy resin, EPR-REZ™ resin 3540—a solid Bisphenol A epoxy resin with an organic co-solvent, or EPR-REZ™ resin 3519—a butadiene-acrylonitrile modified epoxy.

The light absorbing composition includes a light absorbing material and an adhesive polymer. The light absorbing composition forms a light absorbing layer as part of the various waveguide embodiments described above and shown in FIGS. 1-8. The light absorbing material may be any suitable light absorbing material, such as carbon black, a dark material, a dark pigment, or a dark-colored dye. Dark includes black, blue, or any other color that is capable of absorbing ambient or other light entering the waveguide at greater than the acceptance angle. Light entering the waveguide or panel at greater than the acceptance angle needs to be absorbed so it does not travel through the waveguide it entered in to an adjacent waveguide, otherwise the image for the viewer may be fuzzy. The light absorbing material may be a powder or a liquid dispersion wherein particles to be dispersed are about 0.05 μm to about 20 μm. In one embodiment the particles are about 0.05 μm to about 7 μm. In another embodiment the particles are about 0.05 μm to about 1 μm. Carbon black may be obtained from Cabot Corporation, Dick Blick Art Materials, Penn Color, Inc., Solution Dispersions, Inc., Wolstenholme International Ltd., or Color Mate, Inc. In one embodiment, the light absorbing composition may include carbon black and a binder, like an acrylic polymer, to disperse the carbon particles.

A plurality of any of the embodiments of the waveguides 8 may be adhered together by positioning an adhesive layer 15 or a light absorbing composition 19 including an adhesive between stacked waveguides 8 and applying heat and/or pressure to the stack to form a panel for use herein. The direction of the waveguides within the front projection screens may be in a vertical or a horizontal orientation, or any orientation therebetween.

Diffuser 24 may be any optical diffuser that alters the angular divergence of incident light. Diffuser 24 may alter the angle of divergence of incoming or outgoing light. The diffuser 24 provides a wider viewing angle for the audience viewing an image on a front projection screen made of stacked waveguides. Diffuser 24 may be either a front diffuser 24A or a back diffuser 24B. In another embodiment, both a front diffuser 24A and a back diffuser 24B may be present, as shown in FIG. 3.

In an embodiment including a front diffuser 24A, see Example 1 below, the front diffuser increased the brightness and image sharpness, and eliminated or substantially reduced the reflection hot spot in comparison to the same panel 20 without a diffuser. A reflective hot spot is an area or spot which gives unusual high reflective bright light across the screen surface. The hot spot may be an enlarged and/or greatly blurred reflection of bright light. The unusual brightness of the hot spot may obstruct the view of the image by distorting the contrast with portion of the image surrounding the hot spot. The viewer may be “blinded” by the hot spot such that the rest of the image appears blurry. The panel including the front diffuser 24A also had better brightness, black density, and image sharpness than a conventional projection screen. Films useful as the diffuser 24 may be available under the trade name Illuminex from GE Advanced Materials, Diffusion Films or Advanced Diffusion Films from Fusion Optixs, Inc., Opalus from Keiwa Inc. of Japan, and Light Shaping Diffusers® from Luminit, LLC. In one embodiment, diffuser 24 may be adhered or laminated to the front surface 21 of the stacked waveguides 8 with an optical adhesive, such as an optical grade acrylic, silicone, epoxy, polyurethane or rubber based adhesive, or combination thereof. In another embodiment, diffuser 24A may be attached to front surface 21 by a tape, a staple, a fastener, any other form of attachment that will securely hold the diffuser in place without interfering with the image to be viewed on the resulting screen, or combinations thereof.

In another embodiment, an anti-glare film or coating may be applied to diffuser 24 to improve the image by reducing the glare and/or surface reflectivity of the screen. In another embodiment, an abrasion resistant coating or film may be applied to diffuser 24 to protect the screen from damage. In another embodiment, a film or coating having both anti-glare and abrasion resistant characteristics may be applied to or may be part of the diffuser 24. In one embodiment, the antiglare and/or abrasion resistant film or coating may be applied to or may be part an incorporated part of the front diffuser 24A. The film may be adhered or laminated to the diffuser 24. An optical grade adhesive may be used, the adhesive should not degrade the diffuser 24. The lamination process may be any method known in the art suitable for bonding the film to the diffuser 24 without degrading the diffuser. The coating may be any coating that has anti-glare and/or abrasion resistance characteristics. The coating may be applied by any method known in the art suitable for applying the coating without damaging the diffuser or the stacked optical waveguides. The coating selected should not react with the materials making up the diffuser 24 nor destroy the diffuser characteristics of diffuser 24. Examples of anti-glare films that also have abrasion resistant characteristics include CV02 film by FUJIFILM and DuPont™ Optilon™ Anti-Reflective Film Coatings by DuPont.

Reflector 29 may be a metal-based material. The metal-based material may be selected from the group consisting of aluminum or aluminum compounds, silver or silver compounds, titanium or titanium compounds, gold or gold compounds, mercury or mercury compounds, barium or barium compounds, stainless steel, and mixtures thereof. Reflector 29 may be in the form of a film, mirror, paper, glass, paint, or other suitable medium for placement of the reflective material at the back face 22 of the stacked waveguides 8. In one embodiment the reflective material is a metallized film including aluminum, silver, or a mixture thereof. The metallized film may be placed behind or on the back face 22 of the stacked waveguides 8 by vapor deposition or via an optical adhesive. In one embodiment the metallized film may be sandwiched between an optical grade polymer to protect the metal within the metallized film from reacting with compounds in the air, i.e. oxygen, nitrogen, sulfur, water vapor. The metallized film may be protected by an overcoat of or laminated between a protective material such as polyethylene terephthalate. In embodiments utilizing a back diffuser 24B, the reflector 29 may be placed behind or on the side of the back diffuser 24B opposite the back face 22 of the stacked waveguides 8.

In another embodiment, reflector 29 may be a microporous PTFE or polyester comprising polymeric sheet. Examples of microporous PTFE or polyester comprising polymeric sheet includes Gore™ DRP® Diffuse Reflector by W. L. Gore & Associates and DuPont™ Optilon™ Advanced Composite Reflector by Dupont. Reflector 29 in film form may be adhered to the back face 22 of waveguides 8 with an optical adhesive or tape. In another embodiment, the reflector 29 may be a photographic paper. In one embodiment, the photographic paper may include titanium dioxide. The photographic paper may be adhered to the back face 22 with an optical adhesive or tape. In another embodiment, reflector 29 may be a reflective paint or reflective coating that may be painted, coated, or sprayed onto the back face 22. In one embodiment, the reflective paint or reflective coating may be a substantially white. In another embodiment, the reflective paint or coating may be of any paint that includes reflective beads or fillers. In another embodiment, reflector 29 may alternatively be of a type such as reflector 19 in U.S. Pat. No. 6,535,674 issued to Veligdan. The reflector 29 may be in the form of a light directing film such as, for example, a transmissive right angle film such as, for example, TRAF II® from the 3M Company.

In one embodiment, the reflector 29 may be a dichroic mirror. The dichroic mirror may be on or behind the back face 22 of the stacked waveguides 8. In another embodiment, a polarized film be placed between the back face 22 of the stacked waveguides 8 and the dichroic mirror. The dichroic mirror may be selected to reflect particular colors (i.e., wavelengths) of light while allowing other colors (i.e., wavelengths) of light to pass through. The dichroic mirror may be selected to substantially reflect light with the red, green and blue wavelengths present in the image light from the projector, while allowing other wavelengths to pass through. Since most projectors project images with discrete wavelength red, green, and blue light, using a dichroic mirror with reflective bands at these wavelengths will eliminate unwanted ambient light with out-of-band wavelengths. Dichroic mirrors may be available from Optical Coatings Japan of type blue, green or red reflecting mirrors and from PerkinElmer under the trade name ViewLux.

The panels including the diffusers are a combination of components (i.e., including the core, the cladding, the light absorbing material, the adhesives, the reflective material, the diffusers, and any other layers present between the above components) that are properly selected to create a panel with an acceptance angle of incident light that will minimize the interference from ambient light, such that the ambient light is absorbed by the light absorbing material within the waveguide. This provides the advantage that the screen made from such a panel will maintain high brightness, contrast and low glare under ambient and other various lighting conditions.

### EXAMPLES

### Example 1

An optical display panel made from waveguides having a polycarbonate core with a refractive index of 1.58 and a cladding with a refractive index less than the refractive index of the core was evaluated to determine the effect of adding a diffuser(s) to the panel. The waveguides were stacked and adhered to one another to form the panel. An aluminum front surface mirror was placed at the back surface of the panel. When a diffuser was included on the panel, an Illuminex brand diffuser from GE Advanced Materials was used. The diffuser was laminated to the appropriate face of the panel as indicated in TABLE 1 below. The resulting panels were evaluated in comparison to a Da-lite conventional screen on a scale of 1 to 5 (where 5 is the best).

TABLE 1

| | | | | | Da-Lite |
|---|---|---|---|---|---|
| | No | Front | Back | Front & Back | Conventional |
| | Diffuser | Diffuser | Diffuser | Diffuser | Screen |
| Viewing Angle | 1 | 3 | 1 | 4 | 5 |
| Brightness | 2 | 3.5 | 3.5 | 2 | 1 |
| Black Density | 3.5 | 3 | 3.5 | 3.5 | 1 |
| Image Sharpness | 1 | 3 | 3 | 3 | 1 |
| Projection Bright | yes | no (good) | yes | no | no |
| Reflective Hot Spot | (not good) | | (not good) | (good) | (good) |
| | | BEST | | 2nd BEST | |

The results show that the panel with a front diffuser only performed the best overall with the highest brightness and no reflective hot spot. The panel that included a front diffuser and a back diffuser performed second best with no reflective hot spot and the highest viewing angle, but lower brightness than the panel with only the front diffuser. Front projection screens having only a back diffuser, as shown by these results, have reflective hot spot that are bad for the viewing image. It was an unexpected result that adding the diffuser on the front would eliminate the reflective hot spot present with the rear diffuser.

Those of ordinary skill in the art will recognize that various modifications and variations may be made to the embodiments described above without departing from the spirit and scope of the present invention. It is therefore to be understood that the present invention is not limited to the particular embodiments disclosed above, but it is intended to cover such modifications and variations as defined by the following claims.

What is claimed:

1. An optical display panel for a front projection screen, the optical panel comprising:
a plurality of stacked optical waveguides, each stacked waveguide including an optical core having a first and a second surface, a cladding layer on each of the first and second surfaces of the core, wherein the stacked waveguides form a front face and a back face at opposite ends of the stacked waveguides, and wherein images are viewed from the front face of the stacked wave guides;
a diffuser on the front face of the stacked waveguides; and
a reflector on the back face of the stacked waveguides;
wherein each of the stacked waveguides is planar.

2. The optical display panel of claim 1 wherein the reflector is a reflective material or reflective substrate, wherein the reflective material or reflective substrate is comprised of a material selected from the group consisting of aluminum or aluminum compounds, silver or silver compounds, titanium or titanium compounds, gold or gold compounds, mercury or mercury compounds, barium or barium compounds, stainless steel, and mixtures or combinations thereof.

3. The optical display panel of claim 2 wherein the reflector is a metallized film.

4. The optical display panel of claim 3 wherein the metallized film is laminated onto the back face of the stacked waveguides.

5. The optical display panel of claim 2 wherein the reflector is deposited on the back face by vapor deposition or is painted thereon.

6. The optical display panel of claim 1 wherein the diffuser is laminated onto the front face.

7. The optical display panel of claim 1 wherein the diffuser has at least one of an anti-glare or an abrasion-resistant film or coating thereon.

8. The optical display panel of claim 1 wherein the core includes at least one of glass, a polycarbonate, a polymethylmethacrylate, a polycyclic olefin, a polyester, a cellulose, or copolymers thereof.

9. The optical display panel of claim 1 wherein the core has a first refractive index and the cladding layers have a second refractive index, the second refractive index is less than the first refractive index.

10. The optical display panel of claim 9 wherein the core is polycarbonate with a refractive index of about 1.58 and the cladding layers have a refractive index less than about 1.58.

11. The optical display panel of claim 1 wherein the cladding layer includes a light absorbing material.

12. The optical display panel of claim 11 wherein the light absorbing material includes at least one of a carbon black material, a pigment, a dye, or combinations thereof.

13. The optical display panel of claim 1 further comprising a first light absorbing layer applied to the cladding layer that is on the first surface of the optical core and a second light absorbing layer applied to the cladding layer that is on the second surface of the optical core.

14. The optical display panel of claim 13 wherein the light absorbing layer includes a light absorbing material and an adhesive.

15. The optical display panel of claim 1 further comprising an adhesive layer between the cladding layers on consecutively stacked waveguides.

16. The optical display panel of claim 13 further comprising an adhesive layer between the first light absorbing layer and the second light absorbing layer on consecutively stacked waveguides.

17. The optical display panel of claim 1 wherein a dichroic filter is provided between the back face and the reflector, wherein the dichroic filter passes substantially only wavelengths of light corresponding to projected image light forming the images.

18. The optical display of claim 1 wherein the reflector is a dichroic mirror.

19. The optical display of claim 18 wherein the a polarized film is provided between the back face and the dichroic mirror.

20. An optical display panel for a front projection screen, the optical panel comprising:
a plurality of stacked optical waveguides, each stacked waveguide including an optical core having a first and a second surface, a cladding layer on each of the first and second surfaces of the core, wherein the stacked waveguides form a front face and a back face at opposite ends of the stacked waveguides, and wherein images are viewed from the front face of the stacked wave guides;
a front diffuser on the front face of the stacked waveguides;
a back diffuser on the back face of the stacked waveguides; and
a reflector behind the back diffuser on a face of the back diffuser opposite the back face;
wherein each of the stacked waveguides is planar.

21. The optical display panel of claim 20 wherein the reflector is a reflective material or reflective substrate, wherein the reflective material or reflective substrate is comprised of a material selected from the group consisting of aluminum or aluminum compounds, silver or silver compounds, titanium or titanium compounds, gold or gold compounds, mercury or mercury compounds, barium or barium compounds, stainless steel, and mixtures or combinations thereof.

22. The optical display panel of claim 21 wherein the reflector is a metallized film.

23. The optical display panel of claim 22 wherein the back diffuser is laminated between the metallized film and the back face of the waveguides.

24. The optical display panel of claim 23 wherein the back diffuser is applied to the back face of the stacked waveguides and the reflector is deposited on the back diffuser by vapor deposition or is painted thereon.

25. The optical display panel of claim 20 wherein the front diffuser is laminated onto the front face of the stacked waveguides.

26. The optical display panel of claim 20 wherein the front diffuser has at least one of an anti-glare or an abrasion-resistant film or coating thereon.

27. The optical display panel of claim 20 wherein the core includes at least one of glass, a polycarbonate, a polymethylmethacrylate, a polycyclic olefin, a polyester, a cellulose, or copolymers thereof.

28. The optical display panel of claim 20 wherein the core has a first refractive index and the cladding layers have a second refractive index, the second refractive index is less than the first refractive index.

29. The optical display panel of claim 20 wherein the cladding layers include a light absorbing material.

30. The optical display panel of claim 29 wherein the light absorbing material includes at least one of a carbon black material, a pigment, a dye, or combination thereof.

31. The optical display panel of claim 20 further comprising a first light absorbing layer applied to the cladding layer that is on the first surface of the optical core and a second light absorbing layer applied to the cladding layer that is on the second surface of the optical core.

32. The optical display panel of claim 31 wherein the light absorbing layer includes a light absorbing material and an adhesive.

33. The optical display panel of claim 20 further comprising an adhesive layer between the cladding layers on consecutively stacked waveguides.

34. The optical display panel of claim 31 further comprising an adhesive layer between the first light absorbing layer and the second light absorbing layer on consecutively stacked waveguides.

35. The optical display panel of claim 20 wherein a dichroic filter is provided between the back face and the back diffuser, wherein the dichroic filter passes substantially only wavelengths of light corresponding to projected image light forming the images.

36. The optical display panel of claim 20 wherein a dichroic filter is provided between the back diffuser and the reflector, wherein the dichroic filter passes substantially only wavelengths of light corresponding to projected image light forming the images.

37. The optical display of claim 20 wherein the reflector is a dichroic mirror.

38. The optical display of claim 37 wherein the a polarized film is provided between the back face and the dichroic mirror.
